(19) United States
(12) Patent Application Publication
(10) Pub. No.: US 2014/0188367 A1
(43) Pub. Date: Jul. 3, 2014

(54) DISPLAYING INFORMATION ASSOCIATED WITH AN ELECTRIC VEHICLE

(71) Applicant: Recargo, Inc., Venice, CA (US)

(72) Inventors: Forrest North, Venice, CA (US); Armen Petrosian, Venice, CA (US); Lucas Mansfield, Venice, CA (US)

(73) Assignee: Recargo, Inc., Venice, CA (US)

(21) Appl. No.: 14/018,035

(22) Filed: Sep. 4, 2013

Related U.S. Application Data
(60) Provisional application No. 61/696,471, filed on Sep. 4, 2012.

(51) Int. Cl. G07C 5/00

(52) U.S. Cl. CPC G07C 5/008
USPC 701/101; 701/1

(57) ABSTRACT

A system and method for displaying information associated with an electric vehicle via an application located remotely from the electric vehicle is described. In some examples, the system transmit a request to a computing device of an electric vehicle, receives status information about one or more components of the electric vehicle, and presents an indication of a status for the one or more components of the electric vehicle based on the received status information.

### CROSS REFERENCE TO RELATED APPLICATIONS

This application claims priority to U.S. Provisional Patent Application No. 61/696,471, filed on Sep. 4, 2012, entitled DISPLAYING INFORMATION ASSOCIATED WITH AN ELECTRIC VEHICLE, SUCH AS VIA AN INDICATOR ASSOCIATED WITH AN APPLICATION, which is hereby incorporated by reference in its entirety.

### BACKGROUND

Although the adoption of electric vehicles is increasing, there are still many people that find them confusing or inaccessible, or are otherwise not interested in using electric vehicles for their transportation needs. Therefore, technology is being developed to remove such barriers associated with the adoption of electric vehicles.

### BRIEF DESCRIPTION OF THE DRAWINGS

FIG. 1 is a block diagram illustrating components of a suitable computing environment.

FIG. 2 is a block diagram illustrating components of a indicator display system.

FIG. 3A is a flow diagram illustrating a routine performed by a mobile device for displaying indicators associated with an electric vehicle located remotely from the mobile device.

FIG. 3B is a flow diagram illustrating a routine performed by a computing device of an electric vehicle for providing status information to a remotely located mobile device.

FIGS. 4A-4F are displays illustrating various displayed information indicators.

### DETAILED DESCRIPTION

### Overview

A system and method for displaying information associated with an electric vehicle via an application located remotely from the electric vehicle, such as an application, or “app,” provided by a mobile device, is described. In some examples, the system transmits a request to a computing device of an electric vehicle, receives status information about one or more components of the electric vehicle, and presents an indication of a status for the one or more components of the electric vehicle based on the received status information.

For example, the system, in some examples, provides information (e.g., status of charging, use of vehicle, and so on) about an electric vehicle via a status indicator (e.g., an icon) associated with an app of a mobile device, such as a mobile phone, tablet computer, and so on, that is in communication with the electric vehicle.

In some cases, the system periodically or persistently updates the status indicator. In some cases, the system enables a user of an app associated with his/her mobile device to submit a request to update the status indicator. In some cases, the system enables a computing device within the electric vehicle to update the status indicator when certain events occur at the electric vehicle.

The system will now be described with respect to various embodiments. The following description provides specific details for a thorough understanding of, and enabling description for, these embodiments of the system. However, one skilled in the art will understand that the system may be practiced without these details. In other instances, well-known structures and functions have not been shown or described in detail to avoid unnecessarily obscuring the description of the embodiments of the system.

It is intended that the terminology used in the description presented below be interpreted in its broadest reasonable manner, even though it is being used in conjunction with a detailed description of certain specific embodiments of the system. Certain terms may even be emphasized below; however, any terminology intended to be interpreted in any restricted manner will be overtly and specifically defined as such in this Detailed Description section.

### Suitable System

As described herein, a system capable of displaying indicators, via mobile device applications, that represent information associated with electric vehicles and/or other devices or entities, is described.

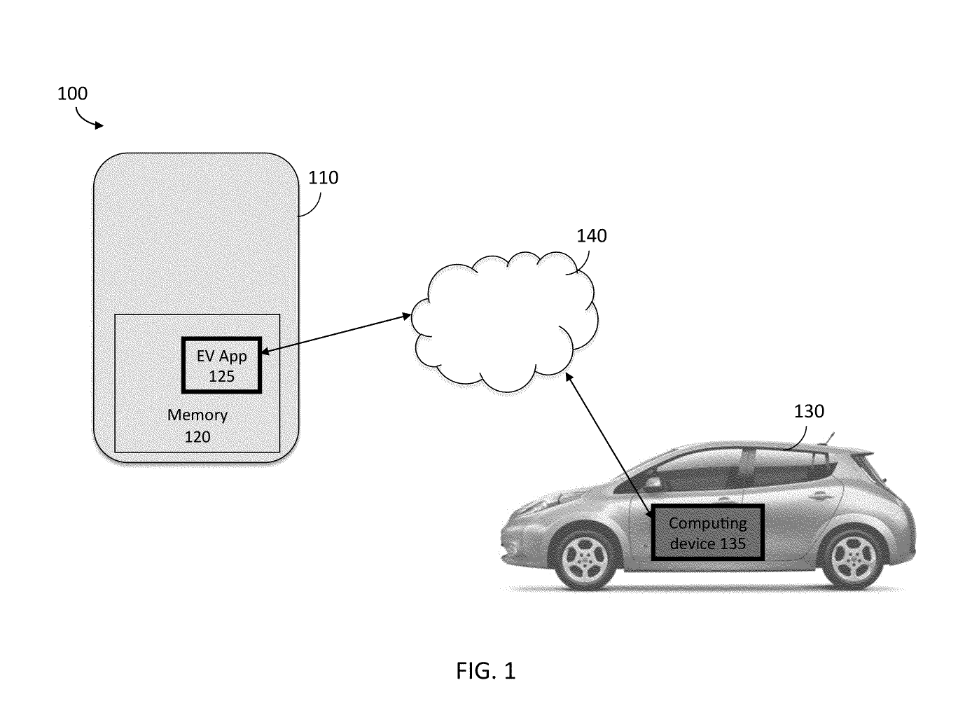

FIG. 1 illustrates components of a suitable computing environment 100 in which the system may be supported and/or implemented. The computing environment 100 includes a mobile device 110, such as a mobile phone or tablet computer that supports and provides applications, or “apps,” to a user of the mobile device 110, an electric vehicle (EV) 130 (e.g., a vehicle, plugin hybrid, range extended hybrid, electric traction or battery or plugin vehicle), and a network 140 that facilitates communications between the mobile device 110 or apps supported by the mobile device 110, and one or more computing devices 135 within the electric vehicle 130.

The computing device 110 may be a tablet computer, mobile device, smart-phone, net-book, mobile GPS navigation device, remote control, fixed telephone or communications console or apparatus, surface or tabletop computer, overhead image projector, desktop computer, e-reader, ATM machine, vending machine, or any other device that supports, presents, and/or displays apps via a user interface, such as a touch-screen, of the device. The computing device 110 includes various hardware and/or software components in order to provide such functionality. For example, the computing device 110 includes various human interface components, device components, and memory, and so on.

The computing device 110 may include a touch-screen or other input component that provides input to a processor. The touch-screen may include or communicate with a hardware controller, such as a touch-screen driver, that interprets raw signals received from the touch-screen and transmits information associated with a contact event (e.g., a pressing of an app via the touch-screen), to the processor. The touch-screen may be part of a display, such as a touch-screen display, a flat panel display, a cathode ray tube, an electronic ink display, a head-mounted display, a liquid crystal display, a light-emitting diode display, a plasma panel display, an electro-luminescent display, a vacuum fluorescent display, a digital projector, a laser projector, a heads-up display, and so on. The device 110 may include other interface components, such a speaker that provides appropriate auditory signals to assist a user in navigating a touch-screen, and so on.

The computing device 110 may include various device components, such as sensors (e.g., GPS or other location determination sensors, motion sensors, gyroscopes, light sensors, and so on), removable storage devices (e.g., SIM cards), cameras and other video capture devices, microphones and other audio capture devices, communication devices (e.g., Bluetooth devices, radios, antennas), and so on.

The processor 122 may communicate with data or applications stored in memory 120 of the device 110, which may include a combination of temporary and/or permanent storage, and both read-only and writable memory (random access memory or RAM), read-only memory (ROM), writable non-volatile memory such as FLASH memory, hard drives, floppy disks, SIM-based components, and so on. The memory component includes various program components or modules, such as an operating system, and various applications, such as applications downloaded to the device 110. For example, the memory 120 may store applications native to the device that perpetually operate on the device (e.g., a keyboard application that provides a virtual keyboard, a text messaging application, and so on) as well as applications that are downloaded by a user and launched by the device (e.g., applications associated with social networking sites, games, and so on). The memory 120 may store one or more applications 125 associated with an electric vehicle, such as an application that facilitates communications between the computing device 110 and an electric vehicle 130 and/or computing device 135 of the electric vehicle 135.

The memory component 120 may also include various data storage components, such a user data database, or other databases that provide and/or store information for applications executed by the device 110, such as the electric vehicle application 125.

The electric vehicle application 125 communicates over the network 140 with the computing device 135 of the electric vehicle 130. The network 140 may be a Local Area Network (LAN), a Wide Area Network (WAN), the Internet, or other networks capable of facilitating various communications between computing devices.

The computing device 135 of the electric vehicle 130 may include various computing components and/or modules configured and/or programmed to control, manage, diagnose, or otherwise interact with components of the electric vehicle 130. For example, the EV computing device 135 may include an on-board computing system that includes on-board diagnostics, such as components configured and/or programmed to detect and/or receive information from the electric vehicle's engine, battery pack, various sensors, dashboard controls, and so on. The components may detect, sense, and/or capture various types of information, such as outside temperature information, inside temperature information, internal engine or component temperatures, motor rpm information, motor temperature information, power consumption information, charger temperature information, information associated with peak power consumption, location or geographical information, tire pressure information, tire temperature information, information captured by seat pressure sensors, error codes or other operational information, and so on. For example, the components may detect, receive, and/or access motor controller information, such as information associated with the power, voltage, current, frequency, waveform, modulation, and/or regenerative power of the motor of the EV, as well as information from modules which control ancillary functions of the EV, such as information associated with operations of the lights, wipers, anti-lock brakes, seat warmers, music, climate controls, light sensors, smoke sensors, acceleration sensors, and other ancillary operations of an EV.

The computing device 135 may also include various communication components, such as radios or other data transmission devices (e.g., Bluetooth, Wi-Fi-, two-way, and so on) configured and/or programmed to transmit information from the EV computing device 135 to devices located remotely from the electric vehicle 130, such as the computing device 110 that supports the EV application 125.

FIG. 1 and the discussion herein provide a brief, general description of a suitable computing environment in which the electric vehicle application can be supported and implemented. Although not required, aspects of the system are described in the general context of computer-executable instructions, such as routines executed by a general-purpose computer, e.g., mobile device, a server computer, or personal computer. Those skilled in the relevant art will appreciate that the system can be practiced with other communications, data processing, or computer system configurations, including: Internet appliances, hand-held devices (including tablet computers and/or personal digital assistants (PDAs)), all manner of cellular or mobile phones, multi-processor systems, microprocessor-based or programmable consumer electronics, set-top boxes, network PCs, mini-computers, mainframe computers, and the like. Indeed, the terms “computer,” “host,” and “host computer,” and “mobile device” and “handset” are generally used interchangeably herein, and refer to any of the above devices and systems, as well as any data processor.

Aspects of the system can be embodied in a special purpose computing device or data processor that is specifically programmed, configured, or constructed to perform one or more of the computer-executable instructions explained in detail herein. Aspects of the system may also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices.

Aspects of the system may be stored or distributed on computer-readable media (e.g., physical and/or tangible computer-readable storage media, such as non-transitory media), including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the system may be distributed over the Internet or over other networks (including wireless networks) or they may be provided on any analog or digital network (packet switched, circuit switched, or other scheme). Those skilled in the relevant art will recognize that portions of the system reside on a server computer, while corresponding portions reside on a client computer such as a mobile or portable device, and thus, while certain hardware platforms are described herein, aspects of the system are equally applicable to nodes on a network. In an alternative embodiment, the mobile device or portable device may represent the server portion, while the server may represent the client portion.

Examples of Displaying Information Associated with an Electric Vehicle

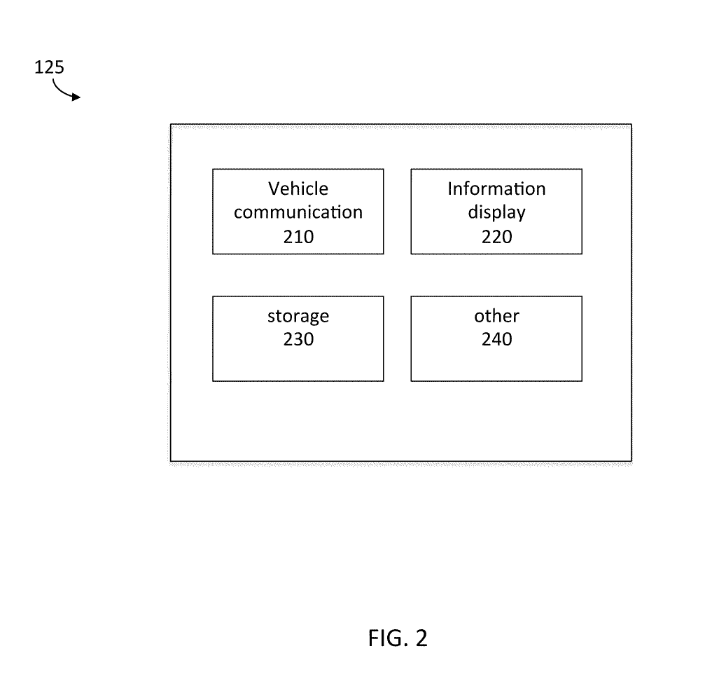

As described herein, in some examples, the system provides information, such as status information for an electric vehicle, via an app indicator displayed by a touch-screen of a mobile device or other computing device. FIG. 2 is a block diagram illustrating components of an application 125 configured to display an indicator representative of a state of one or more components of a remotely located electric vehicle.

In some implementations, the electric vehicle application 125 includes a communication component 210 configured and/or programmed to receive information from a computing device of an electric vehicle, such as computing device 135 of electric vehicle 130. For example, the communication component 210 may transmit a request or other commands to the computing device 135, such as a request to provide information associated with one or more components of the electric vehicle, and may receive such requested information from the EV computing device 135.

In some implementations, the electric vehicle application 125 includes an information display component 220 configured and/or programmed to cause the display of the computing device 110 to present an indicator that is representative of a certain status associated with one or more components of an electric vehicle 130. For example, the information display component 220 may receive information associated with an amount of charge remaining in a battery pack of the electric vehicle 130, and cause an indicator representative of that amount of charge, such as an icon, to be displayed along with the displayed electric vehicle application 125 within a displayed user interface environment of the computing device 110.

In some implementations, the electric vehicle application 125 includes a storage component 230 configured and/or programmed to store data associated with the operation of the system, such as data associated with causing a certain indicator to be displayed along with the electric vehicle application 125. For example, the system may store image or other graphics files for use as indicators or other display elements, may store log information, such as requests for status updates received from users, and so on.

The electric vehicle application 125 may also include other components 240, such as components configured to provide context information, components configured and/or programmed to perform other functions in collaboration with the information display component 220, and so on. For example, the other components 240 may include components that enable a user to provide settings or other use information, components that enable a user to customize the application 125, components that provide security for the application 125, and so on.

The system, therefore, may utilize various components 210-240 when performing routines, algorithms, processes, techniques, and/or other functions in order to provide information about an electric vehicle to a user via the user's mobile device, such as via an indicator associated with a displayed app supported by the mobile device and in communication with the electric vehicle.

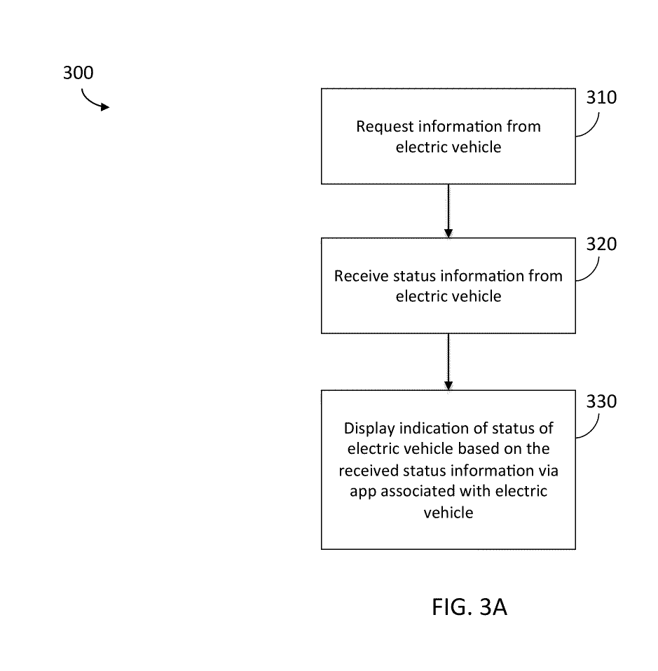

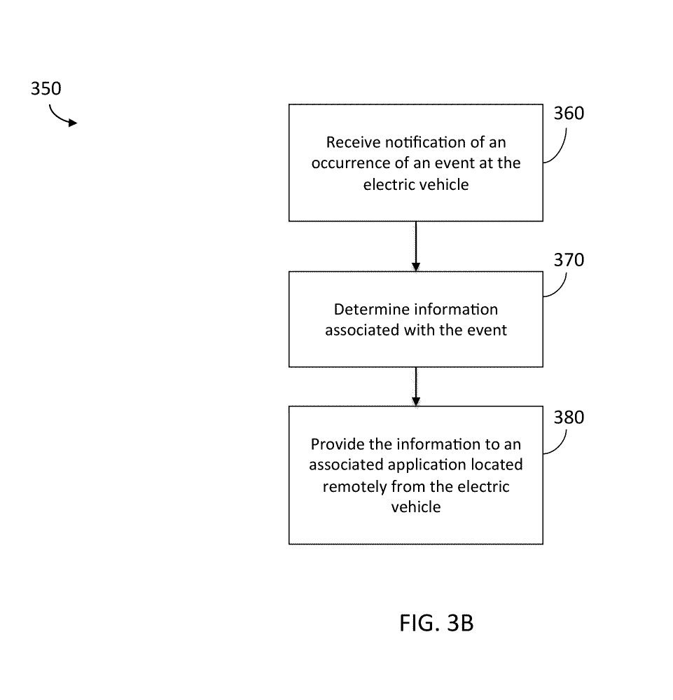

FIG. 3A is a flow diagram illustrating a routine 300 performed by a mobile device for displaying indicators associated with an electric vehicle located remotely from the mobile device.

In operation 310, the EV application 125 supported by the mobile device 110 requests information from the electric vehicle 130. That is, the EV application 125, via the communication component 210, transmits a request for certain information associated with one or more components of the electric vehicle.

The EV application 125 may request the information in a variety of ways. In some cases, the EV application 125 periodically or persistently transmits the request for information. In some cases, the EV application 125 enables a user of the mobile device 110 to provide input that causes the application to transmit the request for information.

In operation 320, the EV application 125 receives, from the computing device 135 of the electric vehicle 130, the requested information. For example, the EV application 125, via the communication component 210, receives the requested information from the computing device 135 of the electric vehicle 130.

As described herein, the EV application 125 may request and receive information associated with various components of the electric vehicle 130. Examples of information that might be requested and received include:
information associated with a battery pack of the electric vehicle, such as information identifying the amount of charge stored by the battery pack, the amount of charging time remaining before the battery pack is full, whether or not the electric vehicle is currently being charged, and other information identifying a current or updated state of the battery pack;
information associated with use or location of the electric vehicle, such as information identifying whether the vehicle is currently in use, information identifying a location of the vehicle, and so on;
information associated with historical use of a battery pack, such as patterns of use (e.g., whether previously received information about a battery pack was in a chronological order, in order to determine the complete state of the chronological logging of information;
and other information described herein.

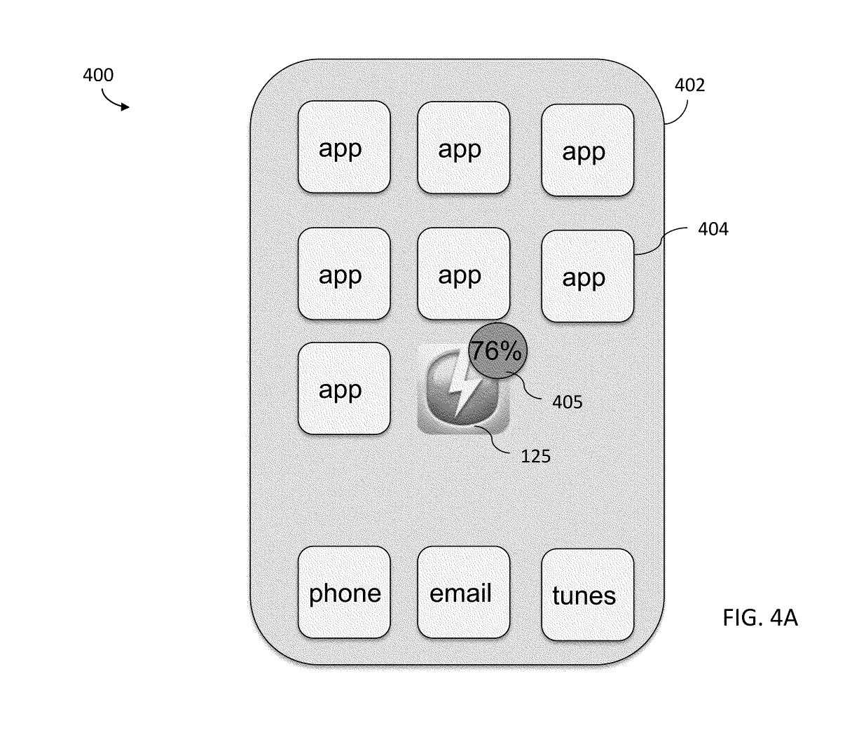

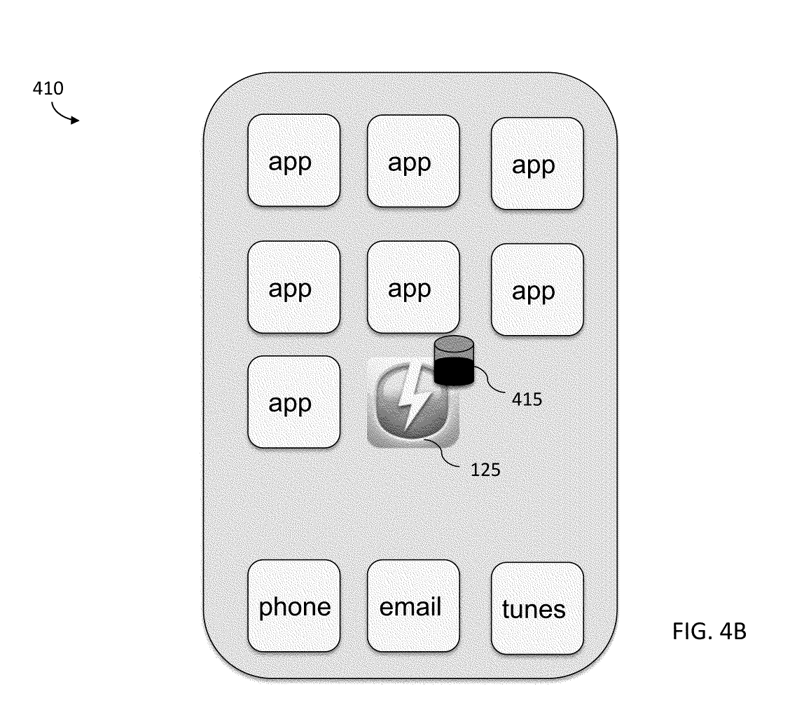

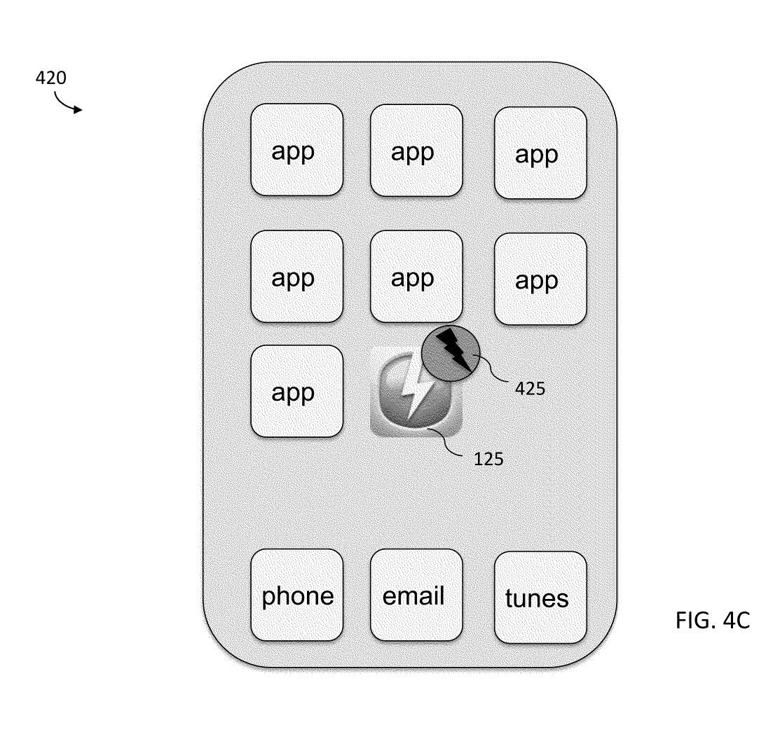

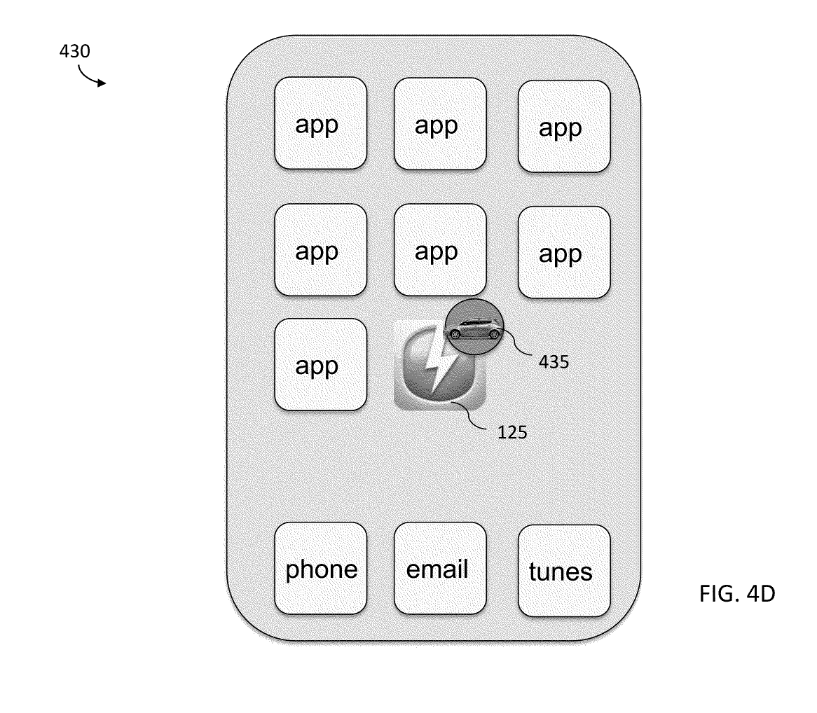

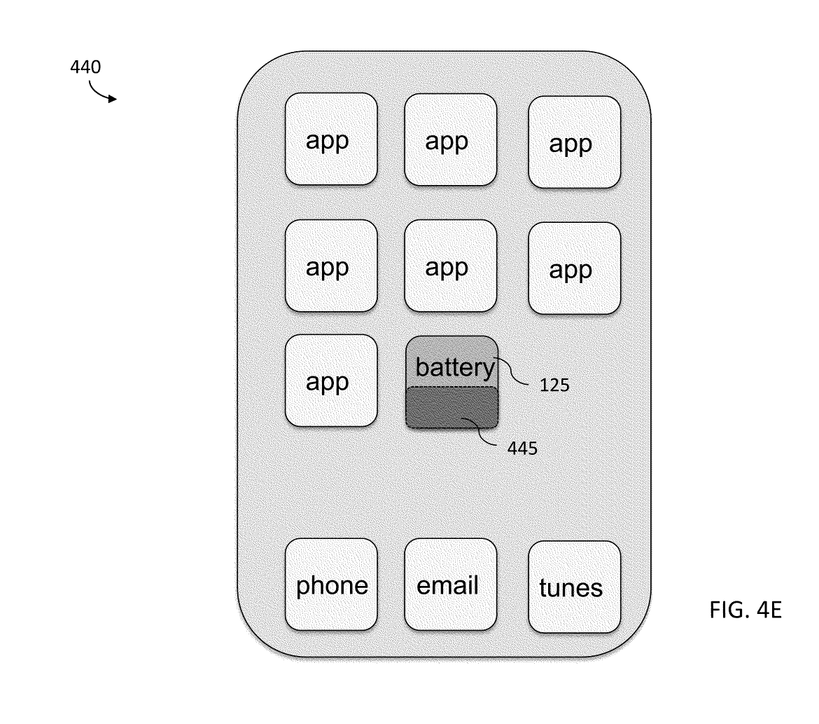

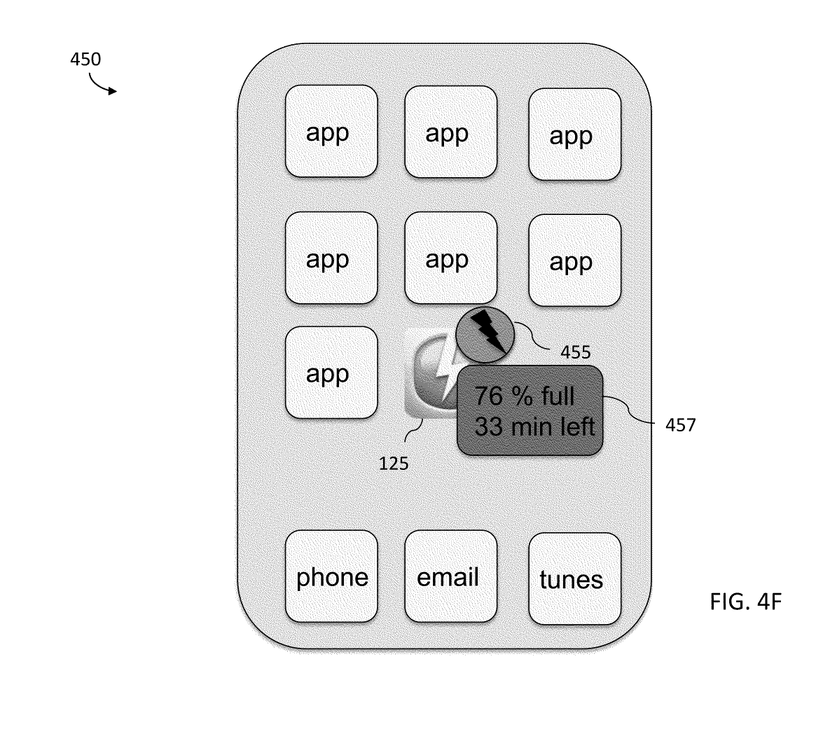

In operation 330, the EV application 125 displays an indicator that represents the received information. For example, the EV application 125, via the information display component 220 and/or the storage component 230, receives the information associated with the electric vehicle, selects one or more images, graphics, icons, or other display elements, and causes the mobile device 110, via the display environment supported by the mobile device, to display an indicator along with the displayed application that is indicative and/or represents the requested and received information. Further details regarding various types of indicators that may be displayed are discussed with respect to FIGS. 4A-4F.

Thus, in some implementations, the system displays an indicator along with an app via a display of a mobile device, where the indicator provides information associated with components of a remotely located electric vehicle.

In some examples, the system may provide information via an app indicator in response to events that occur at an electric vehicle, such as events associated with the charging of an electric vehicle, the use of an electric vehicle, and so on. FIG. 3B is a flow diagram illustrating a routine 350 performed by a computing device of an electric vehicle for providing status information to a remotely located mobile device based on the occurrence of one or more events at an electric vehicle.

In operation 360, the system receives an indication of an occurrence of an event at or within the electric vehicle. For example, the system, via the computing device 135 of the electric vehicle 130, may identify various events associated with one or more components of the electric vehicle to be represented via an indicator of the EV application 125 supported by a remotely located mobile device 110. Examples events that might trigger and/or cause such an indication or notification include:
an event associated with the charging of the vehicle, such as an initiation of the charging, a completion of the charging, a pause or problem with the charging, the charging reaching a certain desired level (such as a predetermined or user-selected amount), and so on;
an event associated with the use of the electric vehicle, such as a beginning of use, an ending of use, the vehicle arriving at a certain location, and so on;
an event associated with a problem or issue for one or more components of the electric vehicle;
an event associated with Successful authentication of vehicle or driver to charging system;
an event associated with a payment success or failure, a station fault, a car fault, an unplanned disconnect, a certain level of charge state (e.g., 80% charge, full charge, 20% more charge than needed to reach home or destination).
an event associated with a towing or theft of an electric vehicle, (e.g., an alarm is triggered, an EV is accelerating in an up direction while car status is off, an EV is unlocked by a different user for car sharing purposes);
an event associated with an problem or possible issue with an EV, such as an excessive external or internal temperature, a short circuit or ground faults, an auxiliary 12 v battery level being too low/high or decreasing/increasing too quickly, main traction batteries being too low/high or decreasing/increasing too rapidly, a 12 v auxiliary battery voltage being out of range, a traction battery voltage out of range; and so on.

In operation 370, the system determines information associated with the event. For example, the system extracts and/or identifies information about the occurrence of the event, such as diagnostic information, status information, use information, and so on.

In operation 380, the system provides, in some cases automatically, the information to an associated application, such as the EV application 125 supported by the mobile device 110 that is located remotely from the electric vehicle. The EV application 125, using the routine 300 or other techniques described herein, may then display an indicator that represents the detected event at the electric vehicle.

Thus, the system, in some examples, may diagnose and/or identify events that occur at an electric vehicle, and provide information, such as warnings, alerts, status updates, and so on, about the events via an app indicator displayed along with an application running on a remotely located mobile device.

As described herein, the system may utilize various display elements when presenting indicators along with apps running on a mobile device. FIGS. 4A-4F are screen shots of mobile device displays that illustrate various displayed information indicators.

FIG. 4A depicts a screen shot 400 of a mobile device 402 that supports many different apps 404, including a displayed EV app 125. The system via the EV app 125, presents an indicator 405 that shows numerical status information (e.g., “76%”), such as information identifying the amount of charge within a battery pack.

FIG. 4B depicts a screen shot 410 the mobile device 402, including the displayed EV app 125. The system, via the EV app 125, presents an indicator 415 that shows visual status information (e.g., an image of a half full battery), such as information identifying the amount of charge within a battery pack.

FIG. 4C depicts a screen shot 420 the mobile device 402, including the displayed EV app 125. The system, via the EV app 125, presents an indicator 425 that shows visual use information (e.g., an image of a lightning bolt), such as information identifying the electric vehicle is currently being charged at a charging station.

FIG. 4D depicts a screen shot 430 the mobile device 402, including the displayed EV app 125. The system, via the EV app 125, presents an indicator 435 that shows visual use information (e.g., an image of a car in motion), such as information identifying the electric vehicle is currently being used.

FIG. 4E depicts a screen shot 440 the mobile device 402, including the displayed EV app 125. The system, via the EV app 125, presents an indicator 445 that shows visual status information by changing the how the EV app 125 is displayed.

FIG. 4F depicts a screen shot 450 the mobile device 402, including the displayed EV app 125. The system, via the EV app 125, presents an indicator 455 that shows visual use information (e.g., an image of a lightning bolt) along with an indicator 457 that shows numerical status information (e.g., “76% full” and “33 min left”). The system may present such an indicator in response to feedback or input received from a user. For example, the system may first present the use information indicator 455, and in response to receiving user input, such as receiving a selection from the user of the indicator via the touch-screen displaying the indicator, may then present the numerical status indicator 457.

Of course, one of ordinary skill in the art will realize that various other display elements, icons, graphics, images, and so on may be utilized by the system when displaying indicators that represent information associated with an electric vehicle.

Thus, in some implementations, the system may provide a user with information about the user's electric vehicle via app indicators that are presented along with a mobile device app that enables the user to interact with his/her electric vehicle. The presentation of such indicators may provide a user with alerts, warnings, updates, and/or other information about his/her electric vehicle in a quick an efficient manner, enabling the user to continually be informed about his/her electric vehicle, among other benefits.

The system described herein, therefore, provides drivers of vehicles, such as electric vehicles, with informational displays that indicate they can reach their destination before returning to their vehicle, that indicate their vehicle has not been unplugged and is continuing to charge, that indicate their vehicle has stopped charging at a certain level to save battery health, cost, or is waiting to charge at a cheaper time based on charging cost information, that alert the user that something is wrong (or, nothing is wrong) with the vehicle, that indicate the vehicle participated in a Demand Response event or charged on Green Renewable or non-green fossil fuel powered electricity, and so on.

In some implementations, the system may utilize the components and routines described herein to present indicators associated with components of devices or systems other than electric vehicles. For example, the system may utilize the components and routines described herein to present indicators associated with other vehicles (vehicles that have internal combustion engines) or transportation devices (e.g., boats, motorcycles, bikes, and so on), household systems (e.g., heating systems, air conditioning systems, security systems, networks, electric systems, and so on), household devices or appliances, among other things.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

While many embodiments described above employ software stored on the mobile device, the scripts and other software noted above may be hard coded into the mobile device (e.g. stored in EEPROM, PROM, etc.). Further, the above functionality may be implemented without scripts or other special modules.

The teachings of the system provided herein can be applied to other systems, not necessarily the system described above. The elements and acts of the various embodiments described above can be combined to provide further embodiments.

All of the above patents and applications and other references, including any that may be listed in accompanying filing papers, are incorporated by reference. Aspects of the system can be modified, if necessary, to employ the systems, functions, and concepts of the various references described above to provide yet further embodiments of the system.

These and other changes can be made to the system in light of the above Detailed Description. While the above description details certain embodiments of the system and describes the best mode contemplated, no matter how detailed the above appears in text, the system can be practiced in many ways. Details of the local-based support system may vary considerably in its implementation details, while still being encompassed by the system disclosed herein. As noted above, particular terminology used when describing certain features or aspects of the system should not be taken to imply that the terminology is being redefined herein to be restricted to any specific characteristics, features, or aspects of the system with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the system are presented below in certain claim forms, the inventors contemplate the various aspects of the system in any number of claim forms. Accordingly, the inventors reserve the right to add additional claims after filing the application to pursue such additional claim forms for other aspects of the system.

We claim:

1. A system provided by a mobile device for providing information associated with an electric vehicle located remotely from the mobile device, the system comprising:
a request component that is configured to submit a request to a computing device associated with an electric vehicle for information associated with a status of a component within the electric vehicle;
a reception component that is configured to receive, at the mobile device, the requested information from the computing device associated with the electric vehicle; and
a display component that is configured to display an indicator representative of the received information associated with the status of the component within the electric vehicle.

2. The system of claim 1, wherein the component within the electric vehicle is a battery pack of the electric vehicle, and wherein the display component is configured to display an indicator representative of an amount of charge within the battery pack.

3. The system of claim 1, wherein the display component is configured to update a displayed indicator in response to the received information associated with the status of the component within the electric vehicle.

4. A method for informing a user of a vehicle about an occurrence of an event at the vehicle, the method comprising:
identifying an occurrence of an event at the vehicle; and
in response to the event, automatically transmitting information associated with the occurrence of the event to a mobile device located remotely from the electric vehicle.

5. The method of claim 4, further comprising:
at the mobile device:
receiving by an application running on the mobile device the information associated with the occurrence of the event; and
displaying an indicator along with an icon of the application running on the mobile device that represents the occurrence of the event.

6. The method of claim 4, wherein identifying an occurrence of an event within the electric vehicle includes identifying a charging of a battery pack associated with the electric vehicle has reached a predetermined threshold amount.

7. The method of claim 4, wherein identifying an occurrence of an event within the electric vehicle includes identifying a charging of a battery pack associated with the electric vehicle has completed.

8. The method of claim 4, wherein identifying an occurrence of an event within the electric vehicle includes identifying a charging of a battery pack associated with the electric vehicle has started or identifying a charging of a battery pack has stopped.

9. The method of claim 4, wherein identifying an occurrence of an event within the electric vehicle includes identifying that the electric vehicle is in use.

10. A computer-readable medium whose contents, when executed by a mobile device, cause the mobile device to perform operations, comprising:
submitting a request to a computing device associated with an electric vehicle for information associated with a status of a component within the electric vehicle;
receiving, at the mobile device, the requested information from the computing device associated with the electric vehicle; and
causing a display of an indicator representative of the received information associated with the status of the component within the electric vehicle.

11. The computer-readable medium of claim 10, wherein the component within the electric vehicle is a battery pack of the electric vehicle, and wherein causing a display of an indicator representative of the received information includes displaying an indicator representative of an amount of charge within the battery pack.

12. The computer-readable medium of claim 10, wherein causing a display of an indicator representative of the received information includes updating a displayed indicator in response to the received information associated with the status of the component within the electric vehicle.

13. The computer-readable medium of claim 10, further comprising:
identifying an occurrence of an event within the electric vehicle; an
submitting the request to the computing device associated with the electric vehicle for information associated with a status of a component within the electric vehicle that is associated with the event.

14. The computer-readable medium of claim 10, wherein the component within the electric vehicle is a battery pack of the electric vehicle, and wherein causing a display of an indicator representative of the received information includes displaying an indicator representative of an amount of charging time remaining before the battery pack is full.

15. The computer-readable medium of claim 10, wherein the component within the electric vehicle is a battery pack of the electric vehicle, and wherein causing a display of an indicator representative of the received information includes displaying an indicator representative of a current state of the battery pack.

16. The computer-readable medium of claim 10, wherein the component within the electric vehicle is a location sensor of the electric vehicle, and wherein causing a display of an indicator representative of the received information includes displaying an indicator representative of a current location of the electric vehicle.

17. The computer-readable medium of claim 10, wherein the component within the electric vehicle is a engine component of the electric vehicle, and wherein causing a display of an indicator representative of the received information includes displaying an indicator representative of a current state of the engine component.
